(19) United States
(12) Patent Application Publication
(10) Pub. No.: US 2007/0063481 A1
(43) Pub. Date: Mar. 22, 2007

(54) Front mounted hitch device and hitch alignment system

(76) Inventor: Clinton L. Dozier JR., Kansas City, MO (US)

Correspondence Address: Gerhard P. Shipley, 300 Clayton Court, Lawrence, KS, 66044, US

(21) Appl. No.: 11/509,159

(22) Filed: Aug. 24, 2006

Related U.S. Application Data
(60) Provisional application No. 60/711,254, filed on Aug. 25, 2005.

(51) Int. Cl. B60D 1/155

(52) U.S. Cl. 280/493

(57) ABSTRACT

A hitch device for removably mounting to the front of a towing vehicle using the existing tow hooks or tow points of the towing vehicle so as to allow for front-coupling the towing vehicle with a trailer or other towed vehicle to make maneuvering and positioning the towed vehicle easier. Also, an alignment system for facilitating alignment of first and second complimentary coupling mechanisms of the towing and towed vehicles.

### RELATED APPLICATIONS

The present non-provisional patent application is related to and claims priority benefit of an earlier-filed provisional patent application titled HITCH ALIGNMENT SYSTEM, Ser. No. 60/711,254, filed Aug. 25, 2005. The identified earlier-filed application is hereby incorporated by reference into the present application.

### BACKGROUND OF THE INVENTION

1. Field of the Invention

The present invention relates broadly to hitches and other devices for coupling a towing vehicle with a towed vehicle, such as a trailer, and to devices and methods of aligning complimentary coupling mechanisms. More particularly, the present invention concerns a hitch device adapted to be removably mounted to the front of a towing vehicle using the existing tow hooks or tow points of the towing vehicle so as to allow for front-coupling the towing vehicle with a towed vehicle to make maneuvering and positioning the towed vehicle easier, and further concerns an alignment system for aligning complimentary coupling mechanisms of the towing and towed vehicles.

2. Description of the Prior Art

Boat owners and others who tow trailers are well aware of the relative difficulty of backwardly maneuvering and positioning the trailers, particularly positioning the trailers in relatively narrow spaces or on relatively exact locations. This difficulty arises at least in part because the trailer is coupled with the rear of the towing vehicle which necessitates that both the towing vehicle and trailer be backed into position, and because the towing vehicle is steered by its front wheels such backward motion can be difficult to control.

Such persons are also well aware of the difficulty of initially coupling the towing vehicle to the trailer. In most cases, the complementary coupling mechanisms are not directly visible to the driver of the towing vehicle. When an additional person is available, that person can be positioned so as to be able to view the complementary coupling mechanisms and provide visual or audible directions to the driver of the towing vehicle in order to align the mechanisms for coupling. When an additional person is not present, the driver must exit the towing vehicle to visually inspect the relative positions of the mechanisms, and then reenter the towing vehicle in order to reposition the towing vehicle so as to achieve alignment. In both cases, the procedure is cumbersome at best.

Due to these and other disadvantages in the prior art, a need exists for an improved device for maneuvering and positioning trailers more easily. A need also exists for an alignment system for aligning the complementary coupling mechanisms so as to facilitate coupling the towing vehicle with the trailer.

### SUMMARY OF THE INVENTION

The present invention overcomes the above-described and other problems and disadvantages in the prior art by providing a front-mounted hitch device and a hitch alignment system, which may be used together or separately.

The front-mounted hitch device is adapted to be removably mounted to the front of a towing vehicle using the existing tow hooks or tow points of the towing vehicle so as to allow for front-coupling the towing vehicle with a towed vehicle, such as a trailer, to make maneuvering and positioning the towed vehicle easier In one embodiment, the device broadly comprises a center portion, a left portion, and a right portion. The center portion presents a ball hitch for removably coupling with the towed vehicle.

The left portion extends angularly outward from a first end of the center portion and has a first coupling end presenting a first mounting hole. The left portion may be pivotably coupled with the first end of the center portion so to be independently positionable relative to the center portion. The first coupling end is adapted to cooperate with the first tow hook so that a first bolt can be placed through the first mounting hole in order to removably couple the left portion with the first tow hook of the towing vehicle. The left portion may be divided into two or more left elements, including a left first element and a left end element, which are pivotably coupled together and independently positionable relative to each other. The left end element may be extendable and retractable relative to the left first element.

The right portion extends angularly outward from a second end of the center portion and has a second coupling end presenting a second mounting hole. The right portion is pivotably coupled with the second end of the center portion so to be independently positionable relative to the center portion. The second coupling end is adapted to cooperate with the second tow hook so that a second bolt can be placed through the second mounting hole in order to removably couple the right portion with the second tow hook of the towing vehicle. The right portion is divided into two or more right elements, including a right first element and a right end element, which are pivotably coupled together and independently positionable relative to each other. The right end element is extendable and retractable relative to the right first element.

The device may further include a first polyurethane insert for insertion into the first tow hook and presenting a first hole for closely receiving the first bolt therethrough, and a second polyurethane insert for insertion into the second tow hook and presenting a second hole for closely receiving the second bolt therethrough. The device may also further include a winch removably mounted to the device, and a metal plate associated with the center portion of the device and to which the winch is removably mounted.

The hitch alignment system facilitates alignment of a first coupling mechanism of the towing vehicle, e.g., the ball hitch or portion, and a second coupling mechanism of the towed vehicle. In one embodiment, the system broadly comprises a first indicator and a second indicator. The first indicator includes a first elongated body having a first lower end and a first upper end; a first securement mechanism attached to the first lower end for removably coupling the first indicator with the ball hitch of the first coupling mechanism; a first cap attached to the first upper end for enhancing visibility of the first indicator; and a lower guard substantially surrounding a lower portion of the first elongated body for protecting the elongated body from damage. The second indicator includes a second elongated body having a second lower end and a second upper end; a second securement mechanism attached to the second lower end for removably coupling the second indicator with a receiver portion of the second coupling mechanism; and a second cap attached to the second upper end for enhancing visibility of the second indicator. When the first indicator is positioned on the ball portion it is lower than the second indicator positioned on the receiver portion and directly in line with the receiver portion. When the first and second indicators become sufficiently close the receiver portion physically contacts the lower guard of the first indicator and overcomes the first securement mechanism and tilts or knocks the first indicator off of the ball portion, thereby indicating that the ball and receiver portions are aligned for coupling.

The first and second elongated bodies may each include a substantially cylindrical pole. The first elongated body may be longer than the second elongated body in order to compensate for the lower position of the first indicator. The first and second securement mechanisms may each include a magnet. The first and second caps may each provide more surface area than the uncapped first and second upper ends of the first and second elongated bodies. The lower guard may be substantially cylindrical in shape and extend completely around the lower portion of the first elongated body.

These and other important features of the present invention are described in greater detail in the section titled DETAILED DESCRIPTION OF THE INVENTION, below.

### BRIEF DESCRIPTION OF THE DRAWINGS

A preferred embodiment of the present invention is described in detail below with reference to the attached drawing figures, wherein:

FIG. 1 is a plan view of a preferred first embodiment of the hitch device of the present invention;

FIG. 2 is a cross-sectional elevation view along line A-A of the hitch device shown in FIG. 1;

FIG. 3 is an exploded fragmentary plan view of the hitch device of FIG. 1 as it may be removably coupled with an existing tow hook;

FIG. 4 is a cross-sectional elevation view of the fragmentary view of FIG. 3 unexploded;

FIG. 5 is a plan view of a preferred second embodiment of the hitch device of the present invention;

FIG. 6 is a plan view of the hitch device of FIG. 1 including a winch device;

FIG. 7 is a side elevation view of a preferred embodiment of the alignment system of the present invention prior to achieving alignment of first and second complementary coupling mechanisms of a towing vehicle and a towed vehicle; and

FIG. 8 is a side elevation view of the alignment system of FIG. 7 as alignment of the first and second complementary coupling mechanisms is achieved.

### DETAILED DESCRIPTION OF THE INVENTION

With reference to the figures, a hitch device 10 is herein described, shown, and otherwise disclosed in accordance with the preferred embodiment(s) of the present invention. More specifically, the hitch device 10 is adapted to be removably mounted to the front of a towing vehicle (not shown) using the existing tow hooks 30 (see FIGS. 3 and 4) or tow points of the towing vehicle so as to allow for front-coupling the towing vehicle with a towed vehicle, such as a trailer, to make maneuvering and positioning the towed vehicle easier.

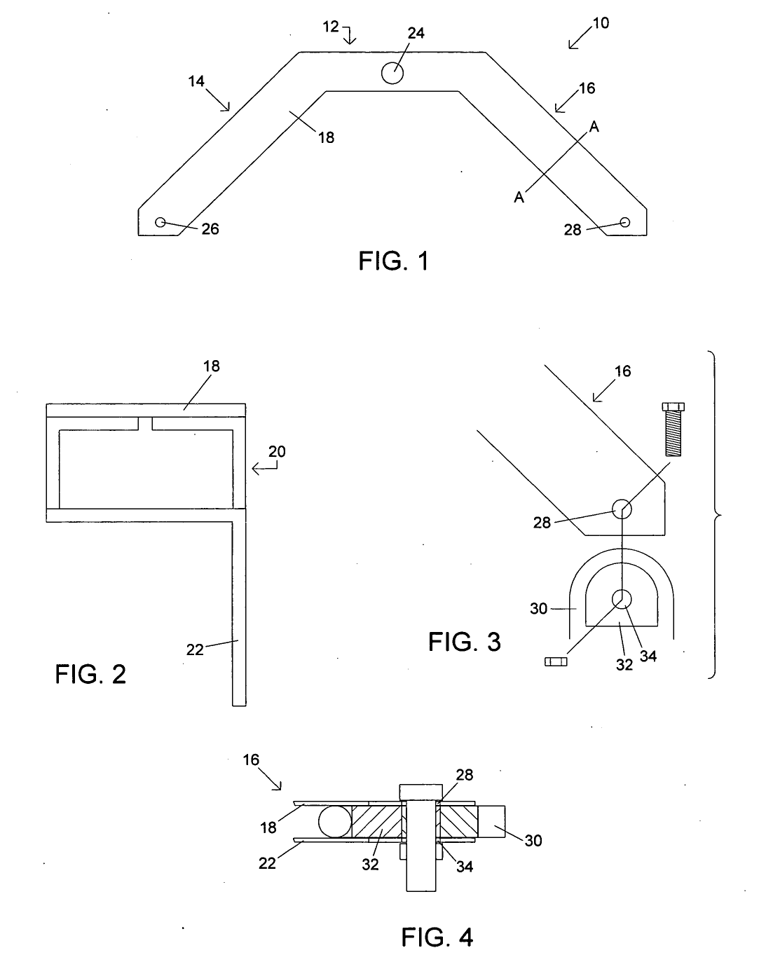

Referring specifically to FIGS. 1 and 2, the device 10 broadly comprises a center portion 12 and left and right portions 14,16, which further comprise an upper portion 18, an intermediate portion 20, and a lower portion 22. The center portion 12 is oriented substantially parallel to a front bumper of the towing vehicle when the device 10 is operatively mounted on the towing vehicle. The center portion 12 presents a ball hitch 24 or other coupling mechanism by which the towed vehicle can be removably coupled with the towing vehicle via the device 10.

The left and right portions 14,16 extend angularly outward from respective opposite ends of the center portion 12 in order to both removably couple with the aforementioned tow hooks 30 (see FIGS. 3 and 4) and space the center portion 12 an appropriate distance from the bumper. The angle and extension of the left and right portions 14,16 will depend on such factors as the distance between the tow hooks 30 and other relevant characteristics of the towing vehicle. In one embodiment, adapted for a particular brand and model of vehicle, the left and right portions 14,16 each extend outward at an angle of 135 degrees from the center portion 12. The ends of the left and right portions 14,16 may be beveled, rounded or otherwise shaped to allow for or better allow for coupling with the tow hooks 30. The ends are provided with respective mounting holes 26,28 for receiving bolts (see FIGS. 3 and 4) for coupling with the tow hooks 30, as is discussed below in greater detail.

Referring specifically to FIG. 2, the upper portion 18 is approximately 2.5 inch by 0.25 inch steel plate which extends as a single piece across the center, left, and right portions 12,14,16. The intermediate portion 20 functions to space the upper portion 18 from the lower portion 22 and to generally stiffen and strengthen the device 10. The intermediate portion 20 may be constructed from two pieces of approximately 1 inch by 1 inch by 0.125 inch angle iron opposingly oriented and welded or otherwise secured to and between the upper and lower portions 18,22. The lower portion 22 also functions to generally stiffen and strengthen the device 10, and may be constructed from 2.5 inch by 2.5 inch by 0.1875 inch angle iron. A portion of the depending leg of the angle iron of the lower portion 22 may be removed near the coupling ends of the left and right portions 14,16 in order to allow for or better allow for engaging the tow hooks 30. It will be appreciated that the aforementioned material and sizes and thicknesses of material may change depending on various factors, including particular design or applications needs. Thus, for example, aluminum might be used in place of steel if the aluminum is made sufficiently thick or otherwise strengthened or stiffened as needed.

Referring specifically to FIGS. 3 and 4, as mentioned, the ends of the left and right portions 14,16 are adapted to removably couple, as with, e.g., bolts and nuts, with respective tow hooks 30. Depending on the design of the tow hook 30, an adaptor 32 may be needed which fits within or within a space defined by the tow hook 30 and provides a through-hole 34 for more closely receiving the aforementioned bolt. The adaptor 32 may be constructed of any suitable material, including, for example, metal, wood, rubber, urethane, or natural or artificial materials including alloys, composites, and synthetics.

In exemplary but non-limiting use and operation, the device 10 may be used and may function as follows. As needed or otherwise appropriate, the inserts 32 are positioned within or otherwise associated with the tow hooks 30 in preparation for receiving the ends of the device 10 and the coupling bolts. Next, the ends of left and right portions 14, 16 of the device 10 are positioned to couple with the towing hooks 30, and bolts or pins are placed through the mounting holes 26,28 of the left and right portions 14,16 and the through-holes 34 of the inserts 32 and appropriately tightened. Then, the towed vehicle can be coupled with the device 10 using the ball hitch 24 or other coupling mechanism. Thereafter, the towed vehicle can be easily maneuvered and positioned using the towing vehicle. Lastly, the device 10 can be quickly and easily unmounted from the towing vehicle by reversing the preceding steps.

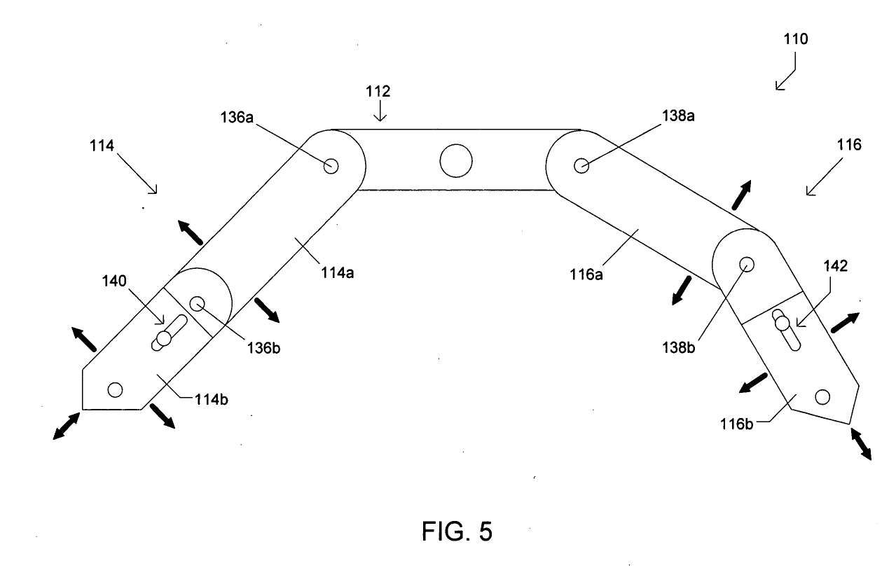

Referring to FIG. 5, a preferred second embodiment of the device 110 is shown which may be substantially similar or even identical to the preferred first embodiment but for the following differences. The center portion 112 and the left and right portions 114,116 are movably coupled, as by one or more bolts or pins 136a,138a, so as to allow for changing the angle of the left and right portions 114,116 with respect to the opposite ends of the center portion 112. Furthermore, the left and right portions 114,116 may be divided into two or more similarly independently movable elements 114a,114b,116a,116b similarly joined by one or more bolts or pins 136b, 138b. Furthermore, the end elements 114b,116b of the left and right portions 114,116 may be made independently extendable using extension mechanisms 140,142 comprising, for example, one or more bolts or pins slidably positioned within movement-restricting channels. It will be appreciated that the increased flexibility provided by the independently positionable and extendable elements of the device 110 allow for accommodating or better accommodating different towing vehicles, different towing hooks, towing hooks spaced different distances apart, and other application-specific challenges.

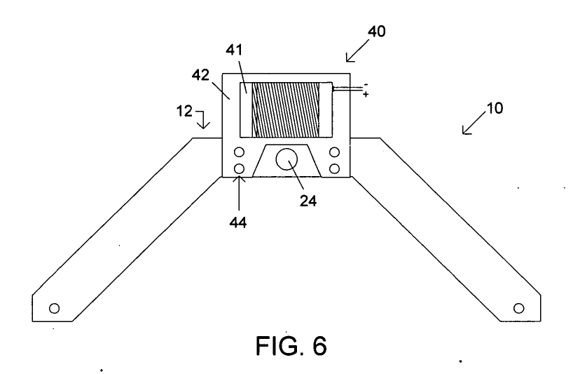

Referring to FIG. 6, the hitch device 10 of FIG. 1 is shown including a winch device 40. The winch device 40 functions in a substantially conventional manner to allow for electronically, mechanically, hydraulically, or otherwise winching, pulling, or drawing in, an object such as a boat or trailer. The winch device 40 includes a winch 41 mounted on a steel plate 42 which is itself bolted to the hitch device 10 using standard bolts 44. It is contemplated that the steel plate 42 may be approximately 0.25 inches thick and as wide and long as necessary to accommodate the winch 41. The winch 41 may be, for example, a substantially conventional electronically driven winch, such as is available from Cummins Industrial Tools, remotely operable and able to winch up to 5000 lbs. Such a winch 41 may be connected to and receive electrical power from the electrical system of the towing vehicle.

With further reference to the figures, an alignment system 200 is also herein described, shown, and otherwise disclosed in accordance with the preferred embodiment(s) of the present invention. More specifically, the alignment system 200 is shown for achieving alignment of first and second complementary coupling mechanisms 202,204 of a towing vehicle and a towed vehicle such as a trailer. The alignment system 200 may be used with the front-mounted hitch device 10 of the present invention or with a conventional rear-mounted hitch device.

The alignment system 200 broadly comprises first and second indicators 206,208, with each indicator 206,208 including a securement mechanism 210, an elongated body 212, and a cap 214. The first indicator 206 also includes a lower guard or bumper 216. At least the cap 214 and preferable the entire indicator 206,208 is colored fluorescent orange or a similarly easily visible color. The securement mechanism 210 allows for at least temporarily associating the first indicator 206 with the ball of the first coupling mechanism 202 and the second indicator 208 with the receiver of the second coupling mechanism 204. Preferably, the securement mechanism 210 is a magnet operable to magnetically retain the indicators 206,208 on their respective metal perches. The elongated body 212 extends substantially vertically upward from the securement mechanism 210 and is sufficiently long so as to be visible by the driver of the towing vehicle over any intervening structures. Preferably the elongated body 212 is a substantially cylindrical or similarly shaped pole constructed of wood, plastic, fiberglass, or other suitable material or combination of materials. The cap 214 is securely positioned on an extreme upward end of the elongated body 212 opposite the securement mechanism 210, and functions both to enhance the visibility of the indicators 206,208 and to improve safety by effectively blunting the exposed end of the elongated body 212. Preferably the cap 214 has a substantially round, flat, or other shape presenting significantly more surface area than the uncapped extreme upward end of the elongated body 212. The lower guard or bumper 216 of the first indicator 206 is located on a lower portion of the elongated body 212 above the securement mechanism 210 and functions to protect the elongated body 212 from damage during impact. Preferably, the lower guard or bumper 216 is substantially cylindrical in shape so as to substantially surround the lower portion of the elongated body 212 and is constructed of plastic, rubber, or other substantially impact-resistant and resilient material or combination of materials.

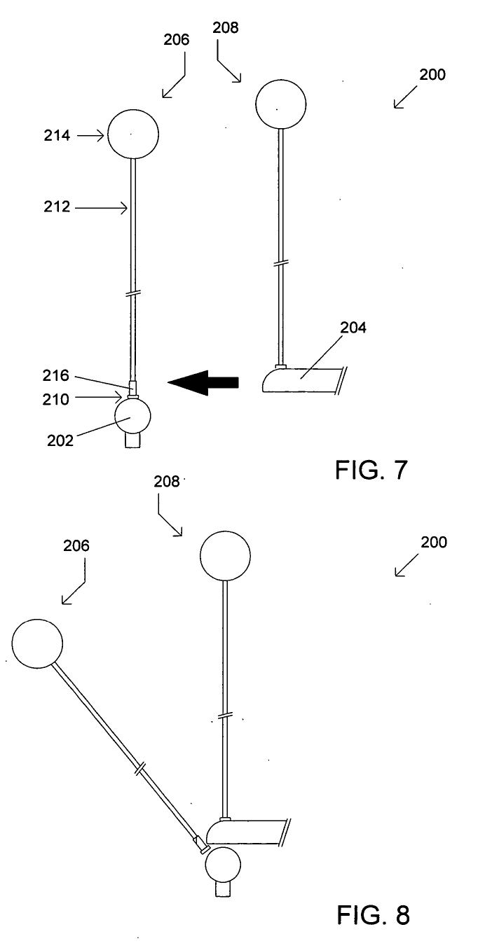

In exemplary but non-limiting use and operation, the alignment system 200 may be used and may function as follows. When it is desired to couple a towing vehicle with a trailer, the first indicator 206 is placed atop the ball portion of the first coupling mechanism 202 of the towing vehicle, and the second indicator 208 is placed atop the receiver portion of the complementary coupling mechanism 204 of the trailer, as shown in FIG. 7. The first indicator 206 will be positioned lower than the second indicator 208 because the ball portion is physically lower than the receiver portion. This places the lower portion of the first indicator 206 in line with the receiver portion. The elongated body 212 of the first indicator 206 may be made longer than the elongated body 212 of the second indicator 208 in order to compensate for this difference in positioning. The driver of the towing vehicle is then able to look in the direction of the coupling mechanisms 202,204 and see at least the upper portion of the indicators 206,208. The driver can then reposition the towing vehicle so as to bring the first and second indicators 206,208 into physical contact. When the indicators 206,208 become sufficiently close, the receiver portion physically contacts the lower guard or bumper 216 of the first indicator 206, thereby overcoming the securement mechanism 210 and tilting or knocking the first indicator 206 off of the ball portion, as shown in FIG. 8. When the driver sees the first indicator 206 being tilted or knocked off of the ball portion, he or she knows that the receiver portion is properly aligned with the ball portion and ready for coupling.

It is also contemplated that, in cases in which even the upper portions of the indicators are not visible to the driver, a remote sensing mechanism may be incorporated into the indicators in order to generate and communicate a signal to the driver in the cab of the towing vehicle. The sensing mechanism may be activated, for example, by the first indicator being knocked off of the ball portion or by the first and second indicators being sufficiently close to one another. The sensing mechanism may provide indication only when the coupling mechanisms are aligned, or may provide changing indications to convey the changing proximity of the coupling mechanisms as they approach alignment.

The hitch device 10 and the alignment system 200 may be used together or separately. It will be appreciated, however, that maximum benefit and ease of coupling and moving the towed vehicle is achieved when these two components are used as part of a system wherein the alignment system 200 is used to align the hitch device 10 for coupling.

Although the invention has been described with reference to the preferred embodiments illustrated in the attached drawings, it is noted that equivalents may be employed and substitutions made herein without departing from the contemplated scope of the invention.

Having thus described the preferred embodiment of the invention, what is claimed as new and desired to be protected by Letters Patent includes the following:

1. A device for mounting to the front of a towing vehicle to allow for coupling a towed vehicle to the front of the towing vehicle, wherein the towing vehicle presents first and second front tow hooks, the device comprising:
a center portion presenting a ball hitch for removably coupling with the towed vehicle;
a left portion extending angularly outward from a first end of the center portion and having a first coupling end presenting a first mounting hole,
wherein the first coupling end is adapted to cooperate with the first tow hook so that a first bolt can be placed through the first mounting hole in order to removably couple the left portion with the first tow hook; and
a right portion extending angularly outward from a second end of the center portion and having a second coupling end presenting a second mounting hole,
wherein the second coupling end is adapted to cooperate with the second tow hook so that a second bolt can be placed through the second mounting hole in order to removably couple the right portion with the second tow hook.

2. The device as set forth in claim 1, further including—
a first polyurethane insert for insertion into the first tow hook and presenting a first hole for closely receiving the first bolt therethrough; and
a second polyurethane insert for insertion into the second tow hook and presenting a second hole for closely receiving the second bolt therethrough

3. The device as set forth in claim 1, wherein—
the left portion is pivotably coupled with the first end of the center portion so as to be independently positionable relative to the center portion; and
the right portion is pivotably coupled with the second end of the center portion so as to be independently positionable relative to the center portion.

4. The device as set forth in claim 1, wherein—
the left portion is divided into two or more left elements, including a left first element and a left end element, which are pivotably coupled together and independently positionable relative to each other; and
the right portion is divided into two or more right elements, including a right first element and a right end element, which are pivotably coupled together and independently positionable relative to each other.

5. The device as set forth in claim 4, wherein—
the left end element is extendable and retractable relative to the left first element; and
the right end element is extendable and retractable relative to the right first element.

6. The device as set forth in claim 1, further including a winch removably mounted to the device.

7. The device as set forth in claim 6, further including a metal plate associated with the center portion of the device and to which the winch is removably mounted.

8. A device for mounting to the front of a towing vehicle to allow for coupling a towed vehicle to the front of the towing vehicle, wherein the towing vehicle presents first and second front tow hooks, the device comprising:
a center portion presenting a ball hitch for removably coupling with the towed vehicle;
a left portion extending angularly outward from a first end of the center portion and having a first coupling end presenting a first mounting hole, with the left portion being pivotably coupled with the first end of the center portion so to be independently positionable relative to the center portion, wherein the first coupling end is adapted to cooperate with the first tow hook so that a first bolt can be placed through the first mounting hole in order to removably couple the left portion with the first tow hook;
a first insert for insertion into the first tow hook and presenting a first hole for closely receiving the first bolt therethrough;
a right portion extending angularly outward from a second end of the center portion and having a second coupling end presenting a second mounting hole, with the right portion is pivotably coupled with the second end of the center portion so to be independently positionable relative to the center portion, wherein the second coupling end is adapted to cooperate with the second tow hook so that a second bolt can be placed through the second mounting hole in order to removably couple the right portion with the second tow hook; and
a second insert for insertion into the second tow hook and presenting a second hole for closely receiving the second bolt therethrough.

9. The device as set forth in claim 8, wherein—
the left portion is divided into two or more left elements, including a left first element and a left end element, which are pivotably coupled together and independently positionable relative to each other; and
the right portion is divided into two or more right elements, including a right first element and a right end element, which are pivotably coupled together and independently positionable relative to each other.

10. The device as set forth in claim 9, wherein—
the left end element is extendable and retractable relative to the left first element; and
the right end element is extendable and retractable relative to the right first element.

11. An alignment system for facilitating alignment of a first coupling mechanism of a towing vehicle and a second coupling mechanism of a towed vehicle, the alignment system comprising:
a first indicator including—
a first elongated body having a first lower end and a first upper end,
a first securement mechanism attached to the first lower end for removably coupling the first indicator with a ball portion of the first coupling mechanism,
a first cap attached to the first upper end for enhancing visibility of the first indicator,
a lower guard substantially surrounding a lower portion of the first elongated body for protecting the first elongated body from damage; and
a second indicator including—
a second elongated body having a second lower end and a second upper end,
a second securement mechanism attached to the second lower end for removably coupling the second indicator with a receiver portion of the second coupling mechanism,
a second cap attached to the second upper end for enhancing visibility of the second indicator,
wherein when the first indicator is positioned on the ball portion it is directly in line with the receiver portion so that when the first and second indicators become sufficiently close the receiver portion physically contacts the lower guard of the first indicator and overcomes the first securement mechanism and tilts or knocks the first indicator off of the ball portion, thereby indicating that the ball and receiver portions are aligned for coupling.

12. The alignment system as set forth in claim 11, wherein the first and second securement mechanisms each include a magnet.

13. The alignment system as set forth in claim 11, wherein the first and second elongated bodies each include a substantially cylindrical pole.

14. The alignment system as set forth in claim 11, wherein the first and second caps each provide more surface area than the uncapped first and second upper ends of the first and second elongated bodies.

15. The alignment system as set forth in claim 11, wherein the lower guard is substantially cylindrical in shape and extends completely around the lower portion of the first elongated body.

16. The alignment system as set forth in claim 11, wherein the first elongated body is longer than the second elongated body in order to compensate for the lower position of the first indicator during use.
